(19) United States
(12) Patent Application Publication
(10) Pub. No.: US 2026/0324631 A1
(43) Pub. Date: Oct. 22, 2026

(54) USE OF AN ALKANEDIOL AS HERBICIDE

(71) Applicant: APEO – AGRONOMICAL PLANT EXTRACTS & ESSENTIAL OILS, Gembloux (BE)

(72) Inventors: Simon DAL MASO, Jambes (BE); Haissam JIJAKLI, Scy (BE); Bérénice FONCOUX, Marche-en-Famenne (BE)

(21) Appl. No.: 18/993,177

(22) PCT Filed: Jul. 11, 2023
(86) PCT No.: PCT/EP2023/069144

§ 371 Date: Jan. 10, 2025

(30) Foreign Application Priority Data
Jul. 11, 2022 (BE) BE2022/5561

(51) Int. Cl. A01N 31/04; A01N 25/04; A01N 25/30; A01P 13/00

(52) U.S. Cl. CPC A01N 31/04; A01N 25/04; A01N 25/30; A01P 13/00

(57) ABSTRACT

The present disclosure relates to a use of a compound of the alkanediol family as a non-selective or selective total herbicide. The disclosure further relates to a use of a compound of the alkanediol family as a non-selective or selective total herbicide for obtaining a phytotoxic effect comprising the inhibition of the germination of the seeds or the destruction of the seeds, the inhibition of the resumption of the underground or aerial development of meristems and buds or the destruction of the underground or aerial meristems and buds, the inhibition of the development and growth of the roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant.

### CROSS-REFERENCE TO RELATED APPLICATION(S)

This present application is a national stage application of International Patent Application No. PCT/EP2023/069144, filed Jul. 11, 2023, which claims priority to Belgium Patent Application No. 2022/5561, filed Jul. 11, 2022, the disclosures of which are hereby incorporated by reference in their entireties.

### TECHNICAL FIELD

This disclosure relates to a use of a compound from the alkanediol family as an herbicide.

### BACKGROUND

Nowadays, weeds are documented as being able to reduce crop yields and interfere with the functions of cultivated plants, even stopping their growth. Weeds are in constant competition with the cultivated plants for water and nutrient resources, reducing yields and the quality of cultivated plants. Economic losses of up to 34% were recorded for the main crops.

At present, the most reliable weed control methods comprise mechanical weeding, manual weeding and the application of herbicides.

Unfortunately, herbicide applications pose a number of problems, the main ones being negative impacts on the environment and negative impacts on animal and human health. Furthermore, the systematic application of the same herbicide molecules increases weed resistance, as the alternative methods (thermal, mechanical, etc.) currently on offer are not very effective and have to be repeated at very regular intervals.

Nowadays, there is a real need to propose and use effective alternative herbicide compounds that will allow to stop using herbicide molecules that are widely and systematically used and for which resistance problems are frequently observed.

In order at least partially to resolve these problems, the present disclosure provides for a use of a compound of the alkanediol family as a non-selective or selective total herbicide, in particular a use of a compound of the alkanediol family as a non-selective or selective total herbicide to obtain a phytotoxic effect comprising the inhibition of the germination of the seeds or the destruction of the seeds, the inhibition of the resumption of the underground or aerial development of meristems and buds or the destruction of the underground or aerial meristems and buds, the inhibition of the development and of the growth of the roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant, said compound of the alkanediol family comprising at least 5 carbon atoms.

More particularly, the present disclosure provides for a use of an alkanediol as a non-selective or selective total herbicide, in particular a use of an alkanediol as a non-selective or selective total herbicide to obtain a phytotoxic effect comprising the inhibition of the germination of the seeds or the destruction of the seeds, the inhibition of the resumption of underground or aerial development of meristems and buds or the destruction of underground or aerial meristems and buds, the inhibition of the development and growth of the roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant, said alkanediol comprising at least 5 carbon atoms.

Alkanediols are organic compounds containing two hydroxyl groups (—OH). Alkanediols are cyclic or linear or branched compounds containing no unsaturation.

In the context of the present disclosure, it has been demonstrated that such a use of a compound from the alkanediol family comprising at least 5 carbon atoms as a non-selective or selective total herbicide is effective in the sense that a use of such a compound gives rise to an increased weed mortality rate (% weed mortality), in particular compared with butane-2,3-diol, which is already known for its herbicidal activity (see the document KR201900477848).

In particular, according to the present disclosure, it has been shown that such a use of a compound of the alkanediol family comprising at least 5 carbon atoms as a non-selective or selective total herbicide allows to obtain at least one phytotoxic effect, including the inhibition of the germination of the seeds or the destruction of the seeds, the inhibition of the resumption of the underground or aerial development of meristems and buds or the destruction of underground or aerial meristems and buds, the inhibition of the development and growth of roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant.

Advantageously, according to the use according to the disclosure, said compound of the alkanediol family comprises 5 to 20 carbon atoms, preferably 6 to 12 carbon atoms. According to the disclosure, said compound of the alkanediol family preferably comprises 5 carbon atoms or 6 carbon atoms or 7 carbon atoms or 8 carbon atoms or 9 carbon atoms or 10 carbon atoms or 11 carbon atoms or 12 carbon atoms or 13 carbon atoms or 14 carbon atoms or 15 carbon atoms or 16 carbon atoms or 17 carbon atoms or 18 carbon atoms or 19 carbon atoms or 20 carbon atoms.

In other words, according to the use according to the disclosure, preferably, said compound of the alkanediol family is a C₅ to C₂₀ compound. According to the disclosure, advantageously, said compound from the alkanediol family is a C₅ compound or a C₆ compound or a C₇ compound or a C₈ compound or a C₉ compound or a C₁₀ compound or a C₁₁ compound or a C₁₂ compound or a C₁₃ compound or a C₁₄ compound or a C₁₅ compound or a C₁₆ compound or a C₁₇ compound or a C₁₈ compound or a C₁₉ compound or a C₂₀ compound.

Preferably, according to the use according to the disclosure, said compound of the alkanediol family comprising at least 5 carbon atoms is a linear or cyclic or branched alkanediol.

By way of example, according to the present disclosure, said compound of the alkanediol family may be one of the following compounds: pentane-1,1-diol, pentane-1,2-diol, pentane-1,3-diol, pentane-1,4-diol, pentane-1,5-diol, pentane-2,2-diol, pentane-2,3-diol, pentane-2,4-diol, pentane-3,3-diol, hexane-1,1-diol, hexane-1,2-diol, hexane-1,3-diol, hexane-1,4-diol, hexane-1,5-diol, hexane-1,6-diol, hexane-2,2-diol, hexane-2,3-diol, hexane-2,4-diol, hexane-2,5-diol, hexane-3,3-diol, hexane-3,4-diol, heptane-1,1-diol, heptane-1,2-diol, heptane-1,3-diol, heptane-1,4-diol, heptane-1,5-diol, heptane-1,6-diol, heptane-1,7-diol, heptane-2,2-diol, heptane-2,3-diol, heptane-2,4-diol, heptane-2,5-diol, heptane-2,6-diol, heptane-3,3-diol, heptane-3,4-diol, heptane-3,5-diol, heptane-4,4-diol, octane-1,1-diol, octane-1,2-diol, octane-1,3-diol, octane-1,4-diol, octane-1,5-diol, octane-1,6-diol, octane-1,7-diol, octane-1,8-diol, octane-2,2-diol, octane-2,3-diol, octane-2,4-diol, octane-2,5-diol, octane-2,6-diol, octane-2,7-diol, octane-3,3-diol, octane-3,4-diol, octane-3,5-diol, octane-3,6-diol, octane-4,4-diol, octane-4,5-diol, nonane-1,1-diol, nonane-1,2-diol, nonane-1,3-diol, nonane-1,4-diol, nonane-1,5-diol, nonane-1,6-diol, nonane-1,7-diol, nonane-1,8-diol, nonane-1,9-diol, nonane-2,2-diol, nonane-2,3-diol, nonane-2,4-diol, nonane-2,5-diol, nonane-2,6-diol, nonane-2,7-diol, nonane-2,8-diol, nonane-3,3-diol, nonane-3,4-diol, nonane-3,5-diol, nonane-3,6-diol, nonane-3,7-diol, nonane-4,4-diol, nonane-4,5-diol, nonane-4,6-diol, nonane-5,5-diol, decane-1,1-diol, decane-1,2-diol, decane-1,3-diol, decane-1,4-diol, decane-1,5-diol, decane-1,6-diol, decane-1,7-diol, decane-1,8-diol, decane-1,9-diol, decane-1,10-diol, decane-2,2-diol, decane-2,3-diol, decane-2,4-diol, decane-2,5-diol, decane-2,6-diol, decane-2,7-diol, decane-2,8-diol, decane-2,9-diol, decane-3,3-diol, decane-3,4-diol, decane-3,5-diol, decane-3,6-diol, decane-3,7-diol, decane-3,8-diol, decane-4,4-diol, decane-4,5-diol, decane-4,6-diol, decane-4,7-diol, decane-5,5-diol, decane-5,6-diol, undecane-1,1-diol, undecane-1,2-diol, undecane-1,3-diol, undecane-1,4-diol, undecane-1,5-diol, undecane-1,6-diol, undecane-1,7-diol, undecane-1,8-diol, undecane-1,9-diol, undecane-1,10-diol, undecane-1,11-diol, undecane-2,2-diol, undecane-2,3-diol, undecane-2,4-diol, undecane-2,5-diol, undecane-2,6-diol, undecane-2,7-diol, undecane-2,8-diol, undecane-2,9-diol, undecane-2,10-diol, undecane-3,3-diol, undecane-3,4-diol, undecane-3,5-diol, undecane-3,6-diol, undecane-3,7-diol, undecane-3,8-diol, undecane-3,9-diol, undecane-4,4-diol, undecane-4,5-diol, undecane-4,6-diol, undecane-4,7-diol, undecane-4,8-diol, undecane-5,5-diol, undecane-5,6-diol, undecane-5,7-diol, undecane-6,6-diol, dodecane-1,1-diol, dodecane-1,2-diol, dodecane-1,3-diol, dodecane-1,4-diol, dodecane-1,5-diol, dodecane-1,6-diol, dodecane-1,7-diol, dodecane-1,8-diol, dodecane-1,9-diol, dodecane-1,10-diol, dodecane-1,11-diol, dodecane-1,12-diol, dodecane-2,2-diol, dodecane-2,3-diol, dodecane-2,4-diol, dodecane-2,5-diol, dodecane-2,6-diol, dodecane-2,7-diol, dodecane-2,8-diol, dodecane-2,9-diol, dodecane-2,10-diol, dodecane-2,11-diol, dodecane-3,3-diol, dodecane-3,4-diol, dodecane-3,5-diol, dodecane-3,6-diol, dodecane-3,7-diol, dodecane-3,8-diol, dodecane-3,9-diol, dodecane-3,10-diol, dodecane-4,4-diol, dodecane-4,5-diol, dodecane-4,6-diol, dodecane-4,7-diol, dodecane-4,8-diol, dodecane-4,9-diol, dodecane-5,5-diol, dodecane-5,6-diol, dodecane-5,7-diol, dodecane-5,8-diol, dodecane-6,6-diol, dodecane-6,7-diol, tridecane-1,1-diol, tridecane-1,2-diol, tridecane-1,3-diol, tridecane-1,4-diol, tridecane-1,5-diol, tridecane-1,6-diol, tridecane-1,7-diol, tridecane-1,8-diol, tridecane-1,9-diol, tridecane-1,10-diol, tridecane-1,11-diol, tridecane-1,12-diol, tridecane-1,13-diol, tridecane-2,2-diol, tridecane-2,3-diol, tridecane-2,4-diol, tridecane-2,5-diol, tridecane-2,6-diol, tridecane-2,7-diol, tridecane-2,8-diol, tridecane-2,9-diol, tridecane-2,10-diol, tridecane-2,11-diol, tridecane-2,12-diol, tridecane-3,3-diol, tridecane-3,4-diol, tridecane-3,5-diol, tridecane-3,6-diol, tridecane-3,7-diol, tridecane-3,8-diol, tridecane-3,9-diol, tridecane-3,10-diol, tridecane-3,11-diol, tridecane-4,4-diol, tridecane-4,5-diol, tridecane-4,6-diol, tridecane-4,7-diol, tridecane-4,8-diol, tridecane-4,9-diol, tridecane-4,10-diol, tridecane-5,5-diol, tridecane-5,6-diol, tridecane-5,7-diol, tridecane-5,8-diol, tridecane-5,9-diol, tridecane-6,6-diol, tridecane-6,7-diol, tridecane-6,8-diol, tridecane-7,7-diol, tetradecane-1,1-diol, tetradecane-1,2-diol, tetradecane-1,3-diol, tetradecane-1,4-diol, tetradecane-1,5-diol, tetradecane-1,6-diol, tetradecane-1,7-diol, tetradecane-1,8-diol, tetradecane-1,9-diol, tetradecane-1,10-diol, tetradecane-1,11-diol, tetradecane-1,12-diol, tetradecane-1,13-diol, tetradecane-1,14-diol, tetradecane-2,2-diol, tetradecane-2,3-diol, tetradecane-2,4-diol, tetradecane-2,5-diol, tetradecane-2,6-diol, tetradecane-2,7-diol, tetradecane-2,8-diol, tetradecane-2,9-diol, tetradecane-2,10-diol, tetradecane-2,11-diol, tetradecane-2,12-diol, tetradecane-2,13-diol, tetradecane-3,3-diol, tetradecane-3,4-diol, tetradecane-3,5-diol, tetradecane-3,6-diol, tetradecane-3,7-diol, tetradecane-3,8-diol, tetradecane-3,9-diol, tetradecane-3,10-diol, tetradecane-3,11-diol, tetradecane-3,12-diol, tetradecane-4,4-diol, tetradecane-4,5-diol, tetradecane-4,6-diol, tetradecane-4,7-diol, tetradecane-4,8-diol, tetradecane-4,9-diol, tetradecane-4,10-diol, tetradecane-4,11-diol, tetradecane-5,5-diol, tetradecane-5,6-diol, tetradecane-5,7-diol, tetradecane-5,8-diol, tetradecane-5,9-diol, tetradecane-5,10-diol, tetradecane-6,6-diol, tetradecane-6,7-diol, tetradecane-6,8-diol, tetradecane-6,9-diol, tetradecane-7,7-diol, tetradecane-7,8-diol, pentadecane-1,1-diol, pentadecane-1,2-diol, pentadecane-1,3-diol, pentadecane-1,4-diol, pentadecane-1,5-diol, pentadecane-1,6-diol, pentadecane-1,7-diol, pentadecane-1,8-diol, pentadecane-1,9-diol, pentadecane-1,10-diol, pentadecane-1,11-diol, pentadecane-1,12-diol, pentadecane-1,13-diol, pentadecane-1,14-diol, pentadecane-1,15-diol, pentadecane-2,2-diol, pentadecane-2,3-diol, pentadecane-2,4-diol, pentadecane-2,5-diol, pentadecane-2,6-diol, pentadecane-2,7-diol, pentadecane-2,8-diol, pentadecane-2,9-diol, pentadecane-2,10-diol, pentadecane-2,11-diol, pentadecane-2,12-diol, pentadecane-2,13-diol, pentadecane-2,14-diol, pentadecane-3,3-diol, pentadecane-3,4-diol, pentadecane-3,5-diol, pentadecane-3,6-diol, pentadecane-3,7-diol, pentadecane-3,8-diol, pentadecane-3,9-diol, pentadecane-3,10-diol, pentadecane-3,11-diol, pentadecane-3,12-diol, pentadecane-3,13-diol, pentadecane-4,4-diol, pentadecane-4,5-diol, pentadecane-4,6-diol, pentadecane-4,7-diol, pentadecane-4,8-diol, pentadecane-4,9-diol, pentadecane-4,10-diol, pentadecane-4,11-diol, pentadecane-4,12-diol, pentadecane-5,5-diol, pentadecane-5,6-diol, pentadecane-5,7-diol, pentadecane-5,8-diol, pentadecane-5,9-diol, pentadecane-5,10-diol, pentadecane-5,11-diol, pentadecane-6,6-diol, pentadecane-6,7-diol, pentadecane-6,8-diol, pentadecane-6,9-diol, pentadecane-6,10-diol, pentadecane-7,7-diol, pentadecane-7,8-diol, pentadecane-7,9-diol, pentadecane-8,8-diol, hexadecane-1,1-diol, hexadecane-1,2-diol, hexadecane-1,3-diol, hexadecane-1,4-diol, hexadecane-1,5-diol, hexadecane-1,6-diol, hexadecane-1,7-diol, hexadecane-1,8-diol, hexadecane-1,9-diol, hexadecane-1,10-diol, hexadecane-1,11-diol, hexadecane-1,12-diol, hexadecane-1,13-diol, hexadecane-1,14-diol, hexadecane-1,15-diol, hexadecane-1,16-diol, hexadecane-2,2-diol, hexadecane-2,3-diol, hexadecane-2,4-diol, hexadecane-2,5-diol, hexadecane-2,6-diol, hexadecane-2,7-diol, hexadecane-2,8-diol, hexadecane-2,9-diol, hexadecane-2,10-diol, hexadecane-2,11-diol, hexadecane-2,12-diol, hexadecane-2,13-diol, hexadecane-2,14-diol, hexadecane-2,15-diol, hexadecane-3,3-diol, hexadecane-3,4-diol, hexadecane-3,5-diol, hexadecane-3,6-diol, hexadecane-3,7-diol, hexadecane-3,8-diol, hexadecane-3,9-diol, hexadecane-3,10-diol, hexadecane-3,11-diol, hexadecane-3,12-diol, hexadecane-3,13-diol, hexadecane-3,14-diol, hexadecane-4,4-diol, hexadecane-4,5-diol, hexadecane-4,6-diol, hexadecane-4,7-diol, hexadecane-4,8-diol, hexadecane-4,9-diol, hexadecane-4,10-diol, hexadecane-4,11-diol, hexadecane-4,12-diol, hexadecane-4,13-diol, hexadecane-5,5-diol, hexadecane-5,6-diol, hexadecane-5,7-diol, hexadecane-5,8-diol, hexadecane-5,9-diol, hexadecane-5,10-diol, hexadecane-5,11-diol, hexadecane-5,12-diol, hexadecane-6,6-diol, hexadecane-6,7-diol, hexadecane-6,8-diol, hexadecane-6,9-diol, hexadecane-6,10-diol, hexadecane-6,11-diol, hexadecane-7,7-diol, hexadecane-7,8-diol, hexadecane-7,9-diol, hexadecane-7,10-diol, hexadecane-8,8-diol, hexadecane-8,9-diol, heptadecane-1,1-diol, heptadecane-1,2-diol, heptadecane-1,3-diol, heptadecane-1,4-diol, heptadecane-1,5-diol, heptadecane-1,6-diol, heptadecane-1,7-diol, heptadecane-1,8-diol, heptadecane-1,9-diol, heptadecane-1,10-diol, heptadecane-1,11-diol, heptadecane-1,12-diol, heptadecane-1,13-diol, heptadecane-1,14-diol, heptadecane-1,15-diol, heptadecane-1,16-diol, heptadecane-1,17-diol, heptadecane-2,2-diol, heptadecane-2,3-diol, heptadecane-2,4-diol, heptadecane-2,5-diol, heptadecane-2,6-diol, heptadecane-2,7-diol, heptadecane-2,8-diol, heptadecane-2,9-diol, heptadecane-2,10-diol, heptadecane-2,11-diol, heptadecane-2,12-diol, heptadecane-2,13-diol, heptadecane-2,14-diol, heptadecane-2,15-diol, heptadecane-2,16-diol, heptadecane-3,3-diol, heptadecane-3,4-diol, heptadecane-3,5-diol, heptadecane-3,6-diol, heptadecane-3,7-diol, heptadecane-3,8-diol, heptadecane-3,9-diol, heptadecane-3,10-diol, heptadecane-3,11-diol, heptadecane-3,12-diol, heptadecane-3,13-diol, heptadecane-3,14-diol, heptadecane-3,15-diol, heptadecane-4,4-diol, heptadecane-4,5-diol, heptadecane-4,6-diol, heptadecane-4,7-diol, heptadecane-4,8-diol, heptadecane-4,9-diol, heptadecane-4,10-diol, heptadecane-4,11-diol, heptadecane-4,12-diol, heptadecane-4,13-diol, heptadecane-4,14-diol, heptadecane-5,5-diol, heptadecane-5,6-diol, heptadecane-5,7-diol, heptadecane-5,8-diol, heptadecane-5,9-diol, heptadecane-5,10-diol, heptadecane-5,11-diol, heptadecane-5,12-diol, heptadecane-5,13-diol, heptadecane-6,6-diol, heptadecane-6,7-diol, heptadecane-6,8-diol, heptadecane-6,9-diol, heptadecane-6,10-diol, heptadecane-6,11-diol, heptadecane-6,12-diol, heptadecane-7,7-diol, heptadecane-7,8-diol, heptadecane-7,9-diol, heptadecane-7,10-diol, heptadecane-7,11-diol, heptadecane-8,8-diol, heptadecane-8,9-diol, heptadecane-8,10-diol, heptadecane-9,9-diol, octadecane-1,1-diol, octadecane-1,2-diol, octadecane-1,3-diol, octadecane-1,4-diol, octadecane-1,5-diol, octadecane-1,6-diol, octadecane-1,7-diol, octadecane-1,8-diol, octadecane-1,9-diol, octadecane-1,10-diol, octadecane-1,11-diol, octadecane-1,12-diol, octadecane-1,13-diol, octadecane-1,14-diol, octadecane-1,15-diol, octadecane-1,16-diol, octadecane-1,17-diol, octadecane-1,18-diol, octadecane-2,2-diol, octadecane-2,3-diol, octadecane-2,4-diol, octadecane-2,5-diol, octadecane-2,6-diol, octadecane-2,7-diol, octadecane-2,8-diol, octadecane-2,9-diol, octadecane-2,10-diol, octadecane-2,11-diol, octadecane-2,12-diol, octadecane-2,13-diol, octadecane-2,14-diol, octadecane-2,15-diol, octadecane-2,16-diol, octadecane-2,17-diol, octadecane-3,3-diol, octadecane-3,4-diol, octadecane-3,5-diol, octadecane-3,6-diol, octadecane-3,7-diol, octadecane-3,8-diol, octadecane-3,9-diol, octadecane-3,10-diol, octadecane-3,11-diol, octadecane-3,12-diol, octadecane-3,13-diol, octadecane-3,14-diol, octadecane-3,15-diol, octadecane-3,16-diol, octadecane-4,4-diol, octadecane-4,5-diol, octadecane-4,6-diol, octadecane-4,7-diol, octadecane-4,8-diol, octadecane-4,9-diol, octadecane-4,10-diol, octadecane-4,11-diol, octadecane-4,12-diol, octadecane-4,13-diol, octadecane-4,14-diol, octadecane-4,15-diol, octadecane-5,5-diol, octadecane-5,6-diol, octadecane-5,7-diol, octadecane-5,8-diol, octadecane-5,9-diol, octadecane-5,10-diol, octadecane-5,11-diol, octadecane-5,12-diol, octadecane-5,13-diol, octadecane-5,14-diol, octadecane-6,6-diol, octadecane-6,7-diol, octadecane-6,8-diol, octadecane-6,9-diol, octadecane-6,10-diol, octadecane-6,11-diol, octadecane-6,12-diol, octadecane-6,13-diol, octadecane-7,7-diol, octadecane-7,8-diol, octadecane-7,9-diol, octadecane-7,10-diol, octadecane-7,11-diol, octadecane-7,12-diol, octadecane-8,8-diol, octadecane-8,9-diol, octadecane-8,10-diol, octadecane-8,11-diol, octadecane-9,9-diol, octadecane-9,10-diol, nonadecane-1,1-diol, nonadecane-1,2-diol, nonadecane-1,3-diol, nonadecane-1,4-diol, nonadecane-1,5-diol, nonadecane-1,6-diol, nonadecane-1,7-diol, nonadecane-1,8-diol, nonadecane-1,9-diol, nonadecane-1,10-diol, nonadecane-1,11-diol, nonadecane-1,12-diol, nonadecane-1,13-diol, nonadecane-1,14-diol, nonadecane-1,15-diol, nonadecane-1,16-diol, nonadecane-1,17-diol, nonadecane-1,18-diol, nonadecane-1,19-diol, nonadecane-2,2-diol, nonadecane-2,3-diol, nonadecane-2,4-diol, nonadecane-2,5-diol, nonadecane-2,6-diol, nonadecane-2,7-diol, nonadecane-2,8-diol, nonadecane-2,9-diol, nonadecane-2,10-diol, nonadecane-2,11-diol, nonadecane-2,12-diol, nonadecane-2,13-diol, nonadecane-2,14-diol, nonadecane-2,15-diol, nonadecane-2,16-diol, nonadecane-2,17-diol, nonadecane-2,18-diol, nonadecane-3,3-diol, nonadecane-3,4-diol, nonadecane-3,5-diol, nonadecane-3,6-diol, nonadecane-3,7-diol, nonadecane-3,8-diol, nonadecane-3,9-diol, nonadecane-3,10-diol, nonadecane-3,11-diol, nonadecane-3,12-diol, nonadecane-3,13-diol, nonadecane-3,14-diol, nonadecane-3,15-diol, nonadecane-3,16-diol, nonadecane-3,17-diol, nonadecane-4,4-diol, nonadecane-4,5-diol, nonadecane-4,6-diol, nonadecane-4,7-diol, nonadecane-4,8-diol, nonadecane-4,9-diol, nonadecane-4,10-diol, nonadecane-4,11-diol, nonadecane-4,12-diol, nonadecane-4,13-diol, nonadecane-4,14-diol, nonadecane-4,15-diol, nonadecane-4,16-diol, nonadecane-5,5-diol, nonadecane-5,6-diol, nonadecane-5,7-diol, nonadecane-5,8-diol, nonadecane-5,9-diol, nonadecane-5,10-diol, nonadecane-5,11-diol, nonadecane-5,12-diol, nonadecane-5,13-diol, nonadecane-5,14-diol, nonadecane-5,15-diol, nonadecane-6,6-diol, nonadecane-6,7-diol, nonadecane-6,8-diol, nonadecane-6,9-diol, nonadecane-6,10-diol, nonadecane-6,11-diol, nonadecane-6,12-diol, nonadecane-6,13-diol, nonadecane-6,14-diol, nonadecane-7,7-diol, nonadecane-7,8-diol, nonadecane-7,9-diol, nonadecane-7,10-diol, nonadecane-7,11-diol, nonadecane-7,12-diol, nonadecane-7,13-diol, nonadecane-8,8-diol, nonadecane-8,9-diol, nonadecane-8,10-diol, nonadecane-8,11-diol, nonadecane-8,12-diol, nonadecane-9,9-diol, nonadecane-9,10-diol, nonadecane-9,11-diol, nonadecane-10,10-diol, eicosane-1,1-diol, eicosane-1,2-diol, eicosane-1,3-diol, eicosane-1,4-diol, eicosane-1,5-diol, eicosane-1,6-diol, eicosane-1,7-diol, eicosane-1,8-diol, eicosane-1,9-diol, eicosane-1,10-diol, eicosane-1,11-diol, eicosane-1,12-diol, eicosane-1,13-diol, eicosane-1,14-diol, eicosane-1,15-diol, eicosane-1,16-diol, eicosane-1,17-diol, eicosane-1,18-diol, eicosane-1,19-diol, eicosane-1,20-diol, eicosane-2,2-diol, eicosane-2,3-diol, eicosane-2,4-diol, eicosane-2,5-diol, eicosane-2,6-diol, eicosane-2,7-diol, eicosane-2,8-diol, eicosane-2,9-diol, eicosane-2,10-diol, eicosane-2,11-diol, eicosane-2,12-diol, eicosane-2,13-diol, eicosane-2,14-diol, eicosane-2,15-diol, eicosane-2,16-diol, eicosane-2,17-diol, eicosane-2,18-diol, eicosane-2,19-diol, eicosane-3,3-diol, eicosane-3,4-diol, eicosane-3,5-diol, eicosane-3,6-diol, eicosane-3,7-diol, eicosane-3,8-diol, eicosane-3,9-diol, eicosane-3,10-diol, eicosane-3,11-diol, eicosane-3,12-diol, eicosane-3,13-diol, eicosane-3,14-diol, eicosane-3,15-diol, eicosane-3,16-diol, eicosane-3,17-diol, eicosane-3,18-diol, eicosane-4,4-diol, eicosane-4,5-diol, eicosane-4,6-diol, eicosane-4,7-diol, eicosane-4,8-diol, eicosane-4,9-diol, eicosane-4,10-diol, eicosane-4,11-diol, eicosane-4,12-diol, eicosane-4,13-diol, eicosane-4,14-diol, eicosane-4,15-diol, eicosane-4,16-diol, eicosane-4,17-diol, eicosane-5,5-diol, eicosane-5,6-diol, eicosane-5,7-diol, eicosane-5,8-diol, eicosane-5,9-diol, eicosane-5,10-diol, eicosane-5,11-diol, eicosane-5,12-diol, eicosane-5,13-diol, eicosane-5,14-diol, eicosane-5,15-diol, eicosane-5,16-diol, eicosane-6,6-diol, eicosane-6,7-diol, eicosane-6,8-diol, eicosane-6,9-diol, eicosane-6,10-diol, eicosane-6,11-diol, eicosane-6,12-diol, eicosane-6,13-diol, eicosane-6,14-diol, eicosane-6,15-diol, eicosane-7,7-diol, eicosane-7,8-diol, eicosane-7,9-diol, eicosane-7,10-diol, eicosane-7,11-diol, eicosane-7,12-diol, eicosane-7,13-diol, eicosane-7,14-diol, eicosane-8,8-diol, eicosane-8,9-diol, eicosane-8,10-diol, eicosane-8,11-diol, eicosane-8,12-diol, eicosane-8,13-diol, eicosane-9,9-diol, eicosane-9,10-diol, eicosane-9,11-diol, eicosane-9,12-diol, eicosane-10,10-diol, eicosane-10,11-diol.

Preferably, according to the use according to the disclosure, said compound of the alkanediol family comprising at least 5 carbon atoms is chosen from the group consisting of hexane-1,2-diol, octane-1,2-diol, decane-1,2-diol, dodecane-1,2-diol, octane-1,8-diol, nonane-1,9-diol, pentane-1,2-diol, hexane-1,6-diol, hexane-2,5-diol, and mixtures thereof.

Advantageously, according to the use according to the disclosure, said compound of the alkanediol family comprising at least 5 carbon atoms is an alkanediol of natural origin, for example a bio-sourced alkanediol, or an alkanediol being a co-product of a chemical synthesis method.

In a particularly advantageous way, according to the use according to the disclosure, said compound of the alkanediol family comprising at least 5 carbon atoms is present in a formulation comprising a solvent and/or a co-formulant selected from the group comprising detergents, emulsifiers, surfactants or tensioactives, dispersants, anti-foaming agents, penetration enhancers in the plant tissues, humectants, ionic and non-ionic wetting agents, antioxidants, thickeners, buffers, diluents, and mixtures thereof.

Preferably, according to the use according to the disclosure, said compound from the alkanediol family comprising at least 5 carbon atoms is present in said formulation in a proportion of 0.01% to 50% by volume relative to the total volume of said formulation, preferably in a proportion of 0.5% to 10% by volume relative to the total volume of said formulation, more preferably in a proportion of 1% to 5% by volume relative to the total volume of said formulation.

Preferably, according to the use according to the disclosure, said tensioactive or surfactant is present in said formulation in a proportion of 0.01% to 20% by volume relative to the total volume of said formulation, preferably in a proportion of 0.1% to 10% by volume relative to the total volume of said formulation, more preferably in a proportion of 0.5% to 5% by volume relative to the total volume of said formulation.

Preferably, according to the use according to the disclosure, said solvent is selected from the group consisting of water, alcohols, ketones, esters, fatty acid esters, ethers, polyols, alkanes, vegetable or mineral oils, modified vegetable oils, and mixtures thereof.

Advantageously, according to the use according to the disclosure, said tensioactive or surfactant is chosen from the group consisting of the following compounds: isooctadecanoic acid, propane-1,2,3-triol, propylene glycol alginate, glycerol caprate, casein, sucrose cocoate, glycerol dilaurate, poly(ethylene glycol) distearate, sucrose distearate, docosanamide, polyoxyethylene lauryl ether, polyethylene glycol monoketyl ether, hexaethylene glycol monooctyl ether, polyethylene glycol monooleyl ether, hydroxyethylcellulose, hydroxypropylmethylcellulose, cetyl lactate, lecithin, coconut monoglycerides, monocaprylin, glycerol monohydroxystearate, glycerol monolaurate, sorbitan monolaurate, monomyristin, glycerol monooleate, sorbitan monooleate, sorbitan monopalmitate, myristyl myristate, isopropyl myristate, 2-[bis(2-hydroxyethyl)amino]ethyl octadecanoate, decyl oleate, isooctyl palmitate, 2-[2-hydroxyethyl-[(Z)-octadec-9-enyl]amino]ethanol, polyoxyethylene glycol dodecyl ether, polysorbate 20, polysorbate 40, polysorbate 60, polysorbate 80, polysorbate 85, saponins, sorbitan sesquioleate, polyoxyethylene stearate, sucrose stearate, sorbitan stearate, pentaerythrityl tetrastearate, glycerol trilaurate, sorbitan trioleate, triolein, glycerol tristearate, sorbitan tristearate, and mixtures thereof.

Preferably, according to the use according to the disclosure, said formulation additionally comprises at least one additional compound exhibiting herbicidal properties, for example at least one of the following compounds: 2,4-d, acetic acid, pelargonic acid, aclonifen, amidosulfuron, aminopyralid, beflubutamide, benfluralin, bentazone, bifenox, carbetamide, carfentrazone-ethyl, chlortoluron, clethodim, clomazone, clopyralid, cloquintocet-mexyl, cycloxydim, cyprosulfamide, dicamba, dichloprop-p, diflufenican, dimethenamide-p, ethofumesate, fenoxaprop-p-ethyl, flazasulfuron, florasulam, fluazifop-p-butyl, flufenacet, fluroxypyr, foramsulfuron, glyphosate, halauxifen-methyl, haloxyfop-p-methyl, essential oil, imazamox, iodosulfuron-methyl-sodium, isoxaben, isoxadifen-ethyl, isoxaflutole, ienacile, MCPA, MCPB, mecoprop-p, mefenpyr-diethyl, mesosulfuron-methyl, mesotrione, metamitrone, metazachlor, metobromuron, metribuzin, metsulfuron-methyl, napropamide, nicosulfuron, penoxsulam, phenmedipham, picolinafen, pinoxaden, propaquizafop, propoxycarbazone-na, prosulfocarb, prosulfuron, pyraflufen-ethyl, pyridate, pyroxsulam, quinmerac, quizalofop-p-ethyl, s-metolaclor, sulcotrione, tembotrione, terbuthylazine, thiencarbazone-methyl, thifensulfuron-methyl, tribenuron-methyl, triclopyr, triflusulfuron-methyl, tritosulfuron.

Advantageously, according to the use according to the disclosure, said formulation is in the form of a liquid, in the form of a liquid concentrate to be diluted, in the form of a macroemulsion, a microemulsion or a nanoemulsion, in the form of a concentrated macroemulsion to be diluted, a concentrated microemulsion to be diluted or a concentrated nanoemulsion to be diluted, in the form of a powder, in the form of granules, pills, wettable granules or wettable powder or in the form of an aerosol.

Preferably, according to the use according to the disclosure, said formulation in the form of a liquid, in the form of a liquid concentrate to be diluted, in the form of a macroemulsion, a microemulsion or a nanoemulsion, in the form of a concentrated macroemulsion to be diluted, a concentrated microemulsion to be diluted or a concentrated nanoemulsion to be diluted or in the form of an aerosol, has drops with a drop size distribution D90 equal to 15 μm. Such a drop size distribution D90 has been determined in the context of the present disclosure to be adequate to ensure a sufficient phytotoxic effect, in particular a herbicidal effect.

### SUMMARY

The present disclosure also relates to a method comprising:
applying a compound from the alkanediol family comprising at least 5 carbon atoms to at least part of a plant, a seed or a soil, and
obtaining a non-selective or selective total herbicidal effect, in particular obtaining a phytotoxic effect comprising the inhibition of the germination of the seeds or the destruction of the seeds, the inhibition of the resumption of the underground or aerial development of the meristems and buds or the destruction of the underground or aerial meristems and buds, the inhibition of the development and of the growth of the roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant.

In particular, the present disclosure relates to a method comprising:
applying an alkanediol comprising at least 5 carbon atoms to at least part of a plant, seed or soil, and
obtaining a non-selective or selective total herbicidal effect, in particular obtaining a phytotoxic effect comprising the inhibition of the germination of the seeds or the destruction of the seeds, the inhibition of the resumption of the underground or aerial development of the meristems and buds or the destruction of the underground or aerial meristems and buds, the inhibition of the development and of the growth of the roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant.

Advantageously, according to the method according to the disclosure, said application is performed on the entire plant and/or the leaves and/or the flowers and/or the fruits and/or the seeds on the plant and/or the plantlets and/or the transplanted seedlings and/or the propagation material such as seeds, tubers or rhizomes, by spraying, soaking, injection or administration by fertilisation or irrigation systems.

Preferably, according to the method according to the disclosure, said application of a compound from the alkanediol family comprising at least 5 carbon atoms to at least part of a plant, a seed or a soil, is an application of a compound from the alkanediol family comprising at least 5 carbon atoms chosen from the group consisting of hexane-1,2-diol, octane-1,2-diol, decane-1,2-diol, dodecane-1,2-diol, octane-1,8-diol, nonane-1,9-diol, pentane-1,2-diol, hexane-1,6-diol, hexane-2,5-diol, and mixtures thereof.

### BRIEF DESCRIPTION OF THE FIGURES

Other characteristics, details and advantages of the disclosure will be apparent from the examples given below, by way of non-limitation and with reference to the attached figures.

FIG. 1 illustrates the % mortality of the crimson clover(Trifolium incarnatum L.) (2-3 leaf stage; BBCH 12-13 stage) over time following the application of different compounds from the alkanediol family according to the disclosure.

FIG. 2 illustrates the % mortality of the perennial ryegrass (Lolium perenne L.) (developed stage) over time following the application of different compounds from the alkanediol family according to the disclosure.

FIG. 3 illustrates the % mortality of the crimson clover(Trifolium incarnatum L.) (BBCH 16-17 stage) over time following the application of different compounds from the alkanediol family according to the disclosure in comparison with butane-2,3-diol.

FIG. 4 illustrates the % mortality of the perennial ryegrass (Lolium perenne L.) (BBCH 16-17 stage) over time following the application of different compounds from the alkanediol family according to the disclosure in comparison with butane-2,3-diol.

FIG. 5 illustrates the % mortality of the crimson clover (Trifolium incarnatum L.) (BBCH 16-17 stage) over time following the application of different compounds from the alkanediol family according to the disclosure in comparison with butane-2,3-diol.

FIG. 6 illustrates the % mortality of the perennial ryegrass (Lolium perenne L.) (BBCH 16-17 stage) over time following the application of different compounds from the alkanediol family according to the disclosure in comparison with butane-2,3-diol.

### DETAILED DESCRIPTION

### Examples

Test 1: Use of Compounds from the Alkanediol Family as Herbicides on Clover—Post-Emergence Test

The following compounds from the alkanediol family were tested as herbicides on the clover, in particular on crimson clover (Trifolium incarnatum L.) (2-3 leaf stage; BBCH 12-13 stage): hexane-1,2-diol (Sigma Aldrich); octane-1,2-diol (Sigma Aldrich); decane-1,2-diol (Sigma Aldrich) and dodecane-1,2-diol (Sigma Aldrich).

These four compounds were formulated in water as a solvent in the presence of a surfactant/tensioactive according to the % by volume (v/v) given in Table 1 below.

In practice, the formulations were formed by subsequent additions of alkanediol, surfactant and water, with homogenisation carried out using a “T25 Ultra-turrax®” disperser with a “S25EC-T-C-25F” dispersion tool at 18,000 rpm for two minutes.

TABLE 1

| | Alkanediol | Surfactant (1) | Water | |
|---|---|---|---|---|
| Hexane-1,2-diol | 2% | 2% | 96% | n = 5 |
| Octane-1,2-diol | 2% | 2% | 96% | n = 5 |
| Decane-1,2-diol | 2% | 2% | 96% | n = 5 |
| Dodecane-1,2-diol | 2% | 2% | 96% | n = 5 |

(1) = Tween 20 ® (Sigma Aldrich)

The compositions listed in Table 1 were tested by spraying (100 ml/m²) on crimson clover (Trifolium incarnatum L.) plants (2-3 leaf stage; BBCH 12-13 stage) in 5 repetitions (n=5). In this case, a repetition corresponds to a pot comprising 25 to 30 clover plants. Water was sprayed (100 ml/m²) on other crimson clover (Trifolium incarnatum L.) plants (2-3 leaf stage; BBCH 12-13 stage) (negative control).

After treatment with the different compositions, the plants were maintained under the following conditions: temperature of 25±5° C. and RH (relative humidity) of 60±10%.

The herbicidal effect of the different formulations was evaluated for 10 days, in terms of the percentage of clover plant mortality.

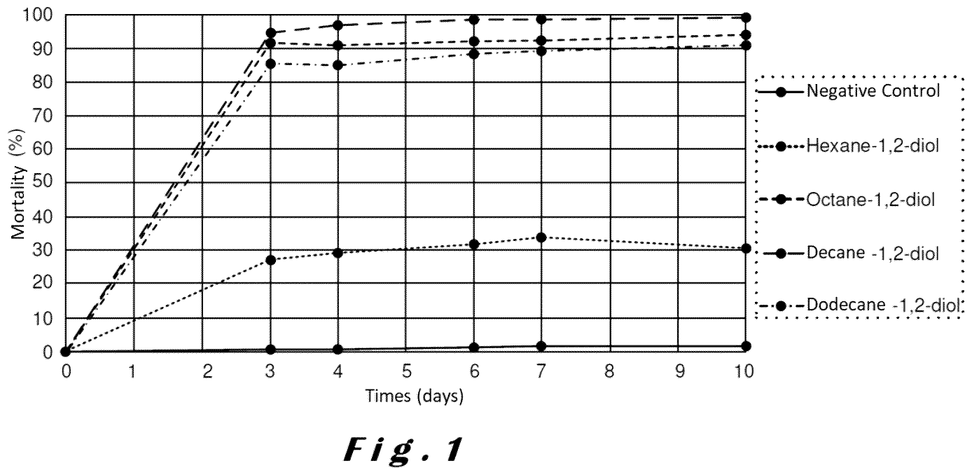

The results are shown in FIG. 1. As may be seen, each of the compounds in the alkanediol family has a herbicidal effect on the crimson clover (Trifolium incarnatum L.), since high % of mortality significantly different from the negative control were measured for each of the formulations.

Test 2: Use of Compounds from the Alkanediol Family as a Herbicide on the Perennial Ryegrass—Post-Emergence Test

The following compounds from the alkanediol family were tested as herbicides on the perennial ryegrass (Lolium perenne L.) (developed stage): hexane-1,2-diol (Sigma Aldrich); octane-1,2-diol (Sigma Aldrich); decane-1,2-diol (Sigma Aldrich) and dodecane-1,2-diol (Sigma Aldrich).

These four compounds were formulated in water as a solvent in the presence of a surfactant/tensioactive according to the % by volume (v/v) given in Table 2 below.

In practice, the formulations were formed by subsequent additions of alkanediol, surfactant and water, with homogenisation carried out using a “T25 Ultra-turrax®” disperser with a “S25EC-T-C-25F” dispersion tool at 18,000 rpm for two minutes.

TABLE 2

| | Alkanediol | Surfactant (1) | Water | |
|---|---|---|---|---|
| Hexane-1,2-diol | 2% | 2% | 96% | n = 5 |
| Octane-1,2-diol | 2% | 2% | 96% | n = 5 |
| Decane-1,2-diol | 2% | 2% | 96% | n = 5 |
| Dodecane-1,2-diol | 2% | 2% | 96% | n = 5 |

(1) = Tween 20 ® (Sigma Aldrich)

The compositions listed in Table 2 were tested by spraying (100 ml/m²) on the perennial ryegrass (Lolium perenne L.) plants (developed stage) in 5 repetitions (n=5). In this case, a repetition corresponds to a pot comprising 40 to 45 perennial ryegrass plants.

Water was sprayed (100 ml/m²) on other perennial ryegrass (Lolium perenne L.) plants (developed stage) (negative control).

After treatment with the different compositions, the plants were maintained under the following conditions: temperature of 25±5° C. and RH (relative humidity) of 60±10%.

The herbicidal effect of the different formulations was assessed over a 10-day period, in terms of the percentage mortality of perennial ryegrass plants.

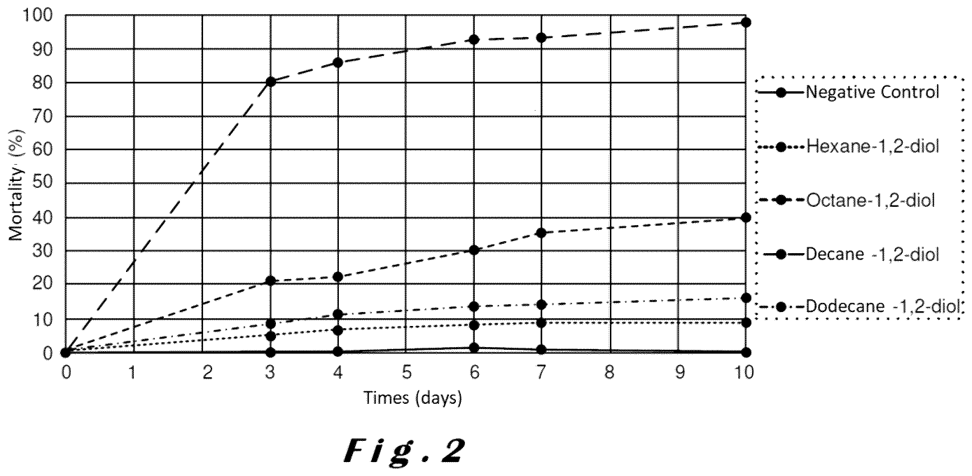

The results are shown in FIG. 2. As may be seen, each of the compounds in the alkanediol family has a herbicidal effect on the perennial ryegrass (Lolium perenne L.) since % mortality significantly different from the negative control was measured for each of the formulations.

Test 3: Use of Compounds from the Alkanediol Family as Herbicides on the Clover—Second Post-Emergence Test

The following compounds were tested as herbicides on the clover, in particular on the crimson clover (Trifolium incarnatum L.) (BBCH stage 16-17): butane-2,3-diol (Sigma Aldrich), hexane-1,2-diol (Sigma Aldrich), octane-1,2-diol (Sigma Aldrich), decane-1,2-diol (Sigma Aldrich), dodecane-1,2-diol (Sigma Aldrich), octane-1,8-diol (Sigma Aldrich) and nonane-1,9-diol (Sigma Aldrich).

These seven compounds were formulated in water as a solvent in the presence of a surfactant/tensioactive according to the % by volume (v/v) given in Table 3 below.

In practice, the formulations were formed by subsequent additions of alkanediol, surfactant and water, with homogenisation carried out using a “T25 Ultra-turrax®” disperser with a “S25EC-T-C-25F” dispersion tool at 18,000 rpm for two minutes.

TABLE 3

| | Alkanediol | Surfactant (1) | Water | |
|---|---|---|---|---|
| Butane-2,3-diol | 2% | 2% | 96% | n = 5 |
| Hexane-1,2-diol | 2% | 2% | 96% | n = 5 |
| Octane-1,2-diol | 2% | 2% | 96% | n = 5 |
| Decane-1,2-diol | 2% | 2% | 96% | n = 5 |
| Dodecane-1,2-diol | 2% | 2% | 96% | n = 5 |
| Octane-1,8-diol | 2% | 2% | 96% | n = 5 |
| Nonane-1,9-diol | 2% | 2% | 96% | n = 5 |

(1) = Tween 20 ® (Sigma Aldrich)

The compositions listed in Table 3 were tested by spraying (100 ml/m²) on the crimson clover (Trifolium incarnatum L.) plants (BBCH 16-17 stage) in 5 repetitions (n=5). In this case, a repetition corresponds to a pot comprising 25 to 30 clover plants.

Water was sprayed (100 ml/m²) on other crimson clover (Trifolium incarnatum L.) plants (BBCH 16-17 stage) (negative control).

After treatment with the different compositions, the plants were maintained under the following conditions: temperature of 25±5° C. and RH (relative humidity) of 60±10%.

The herbicidal effect of the different formulations was evaluated for 10 days, in terms of the percentage of clover plant mortality.

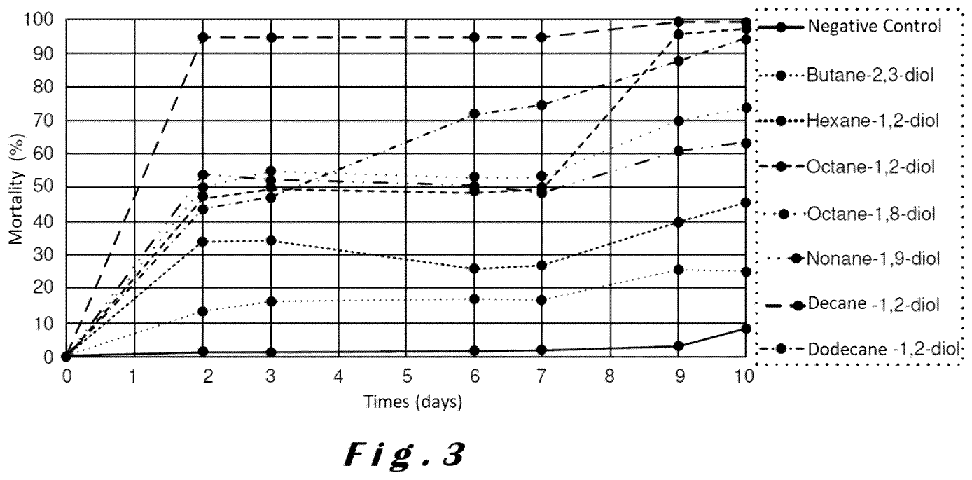

The results are shown in FIG. 3. As may be seen, hexane-1,2-diol, octane-1,2-diol, decane-1,2-diol, dodecane-1,2-diol, octane-1,8-diol and nonane-1,9-diol systematically show an increased herbicidal activity on the crimson clover (Trifolium incarnatum L.) compared with the herbicidal activity observed for butane-2,3-diol. In fact, the % mortality measured for hexane-1,2-diol, octane-1,2-diol, decane-1,2-diol, dodecane-1,2-diol, octane-1,8-diol and nonane-1,9-diol are always higher than for butane-2,3-diol.

In addition, each of these compounds from the alkanediol family had a herbicidal effect on the crimson clover (Trifolium incarnatum L.), since % mortality significantly different from the negative control was measured for each of the formulations.

Test 4: Use of Compounds from the Alkanediol Family as a Herbicide on the Perennial Ryegrass—Second Post-Emergence Test

The following compounds were tested as herbicides on the perennial ryegrass (Lolium perenne L.) (BBCH 16-17 stage): butane-2,3-diol (Sigma Aldrich), hexane-1,2-diol (Sigma Aldrich), octane-1,2-diol (Sigma Aldrich), decane-1,2-diol (Sigma Aldrich), dodecane-1,2-diol (Sigma Aldrich), octane-1,8-diol (Sigma Aldrich) and nonane-1,9-diol (Sigma Aldrich).

These seven compounds were formulated in water as a solvent in the presence of a surfactant/tensioactive according to the % by volume (v/v) given in Table 4 below.

In practice, the formulations were formed by subsequent additions of alkanediol, surfactant and water, with homogenisation carried out using a “T25 Ultra-turrax®” disperser with a “S25EC-T-C-25F” dispersion tool at 18,000 rpm for two minutes.

TABLE 4

| | Alkanediol | Surfactant (1) | Water | |
|---|---|---|---|---|
| Butane-2,3-diol | 2% | 2% | 96% | n = 5 |
| Hexane-1,2-diol | 2% | 2% | 96% | n = 5 |
| Octane-1,2-diol | 2% | 2% | 96% | n = 5 |
| Decane-1,2-diol | 2% | 2% | 96% | n = 5 |
| Dodecane-1,2-diol | 2% | 2% | 96% | n = 5 |
| Octane-1,8-diol | 2% | 2% | 96% | n = 5 |
| Nonane-1,9-diol | 2% | 2% | 96% | n = 5 |

(1) = Tween 20 ® (Sigma Aldrich)

The compositions listed in Table 4 were tested by spraying (100 ml/m²) on perennial ryegrass (Lolium perenne L.) plants (BBCH 16-17 stage) in 5 repetitions (n=5). In this case, a repetition corresponds to a pot comprising 40 to 45 perennial ryegrass plants. Water was sprayed (100 ml/m²) on other perennial ryegrass (Lolium perenne L.) plants (BBCH 16-17 stage) (negative control).

After treatment with the different compositions, the plants were maintained under the following conditions: temperature of 25±5° C. and RH (relative humidity) of 60±10%.

The herbicidal effect of the different formulations was assessed over a 10-day period, in terms of the percentage mortality of perennial ryegrass plants.

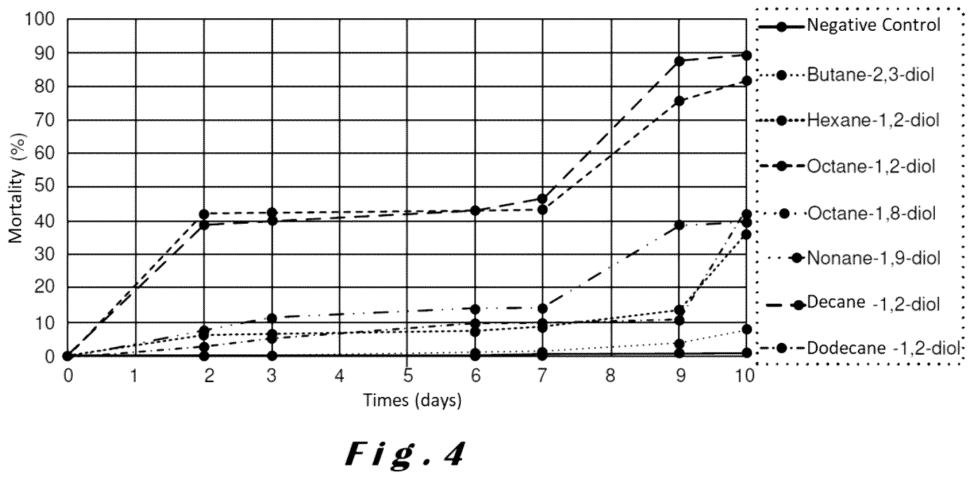

The results are shown in FIG. 4. As may be seen, hexane-1,2-diol, octane-1,2-diol, decane-1,2-diol, dodecane-1,2-diol, octane-1,8-diol and nonane-1,9-diol systematically show an increased herbicidal activity on the perennial ryegrass (Lolium perenne L.) compared with the herbicidal activity observed for butane-2,3-diol. In fact, the % mortality measured for hexane-1,2-diol, octane-1,2-diol, decane-1,2-diol, dodecane-1,2-diol, octane-1,8-diol and nonane-1,9-diol are always higher than for butane-2,3-diol.

In addition, each of these compounds from the alkanediol family had a herbicidal effect on the perennial ryegrass (Lolium perenne L.), since % mortality significantly different from the negative control were measured for each of the formulations.

Test 5: Use of Compounds from the Alkanediol Family as Herbicides on the Clover—Third Post-Emergence Test

The following compounds were tested as herbicides on the clover, in particular on the crimson clover (Trifolium incarnatum L.) (BBCH 16-17 stage): butane-2,3-diol (Sigma Aldrich), hexane-1,6-diol (Sigma Aldrich), hexane-2,5-diol (Sigma Aldrich) and pentane-1,2-diol (Sigma Aldrich).

These four compounds were formulated in water as a solvent in the presence of a surfactant/tensioactive according to the % by volume (v/v) given in Table 5 below.

In practice, the formulations were formed by subsequent additions of alkanediol, surfactant and water, with homogenisation carried out using a “T25 Ultra-turrax®” disperser with a “S25EC-T-C-25F” dispersion tool at 18,000 rpm for two minutes.

TABLE 5

| | Alkanediol | Surfactant (1) | Water | |
|---|---|---|---|---|
| Butane-2,3-diol | 2% | 2% | 96% | n = 5 |
| Hexane-1,6-diol | 2% | 2% | 96% | n = 5 |
| Hexane-2,5-diol | 2% | 2% | 96% | n = 5 |
| Pentane-1,2-diol | 2% | 2% | 96% | n = 5 |

(1) = Tween 20 ® (Sigma Aldrich)

The compositions listed in Table 5 were tested by spraying (100 ml/m²) on crimson clover (Trifolium incarnatum L.) plants (BBCH 16-17 stage) in 5 repetitions (n=5). In this case, a repetition corresponds to a pot comprising 25 to 30 clover plants.

Water was sprayed (100 ml/m²) on other crimson clover (Trifolium incarnatum L.) plants (BBCH 16-17 stage) (negative control).

After treatment with the different compositions, the plants were maintained under the following conditions: temperature of 25±5° C. and RH (relative humidity) of 60±10%.

The herbicidal effect of the different formulations was evaluated for 10 days, in terms of the percentage of clover plant mortality.

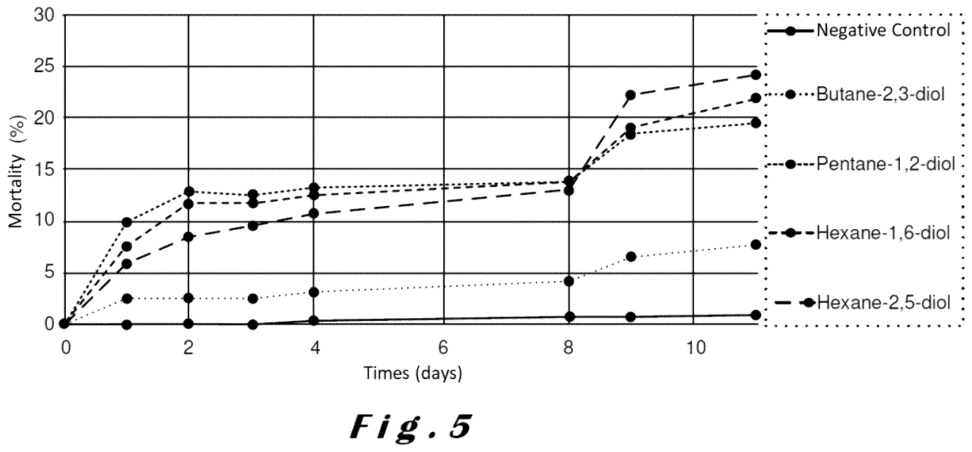

The results are shown in FIG. 5. As may be seen, hexane-1,6-diol, hexane-2,5-diol and pentane-1,2-diol systematically show an increased herbicidal activity on the crimson clover (Trifolium incarnatum L.) compared with the herbicidal activity observed for butane-2,3-diol. In fact, the % mortality measured for hexane-1,6-diol, hexane-2,5-diol and pentane-1,2-diol are always higher than for butane-2,3-diol.

In addition, each of these compounds from the alkanediol family had a herbicidal effect on the crimson clover (Trifolium incarnatum L.), since % mortality significantly different from the negative control was measured for each of the formulations.

Test 6: Use of Compounds from the Alkanediol Family as a Herbicide on the Perennial Ryegrass—Third Post-Emergence Test

The following compounds were tested as herbicides on the perennial ryegrass (Lolium perenne L.) (BBCH 16-17 stage): butane-2,3-diol (Sigma Aldrich), hexane-1,6-diol (Sigma Aldrich), hexane-2,5-diol (Sigma Aldrich) and pentane-1,2-diol (Sigma Aldrich).

These four compounds were formulated in water as a solvent in the presence of a surfactant/tensioactive according to the % by volume (v/v) given in Table 6 below.

In practice, the formulations were formed by subsequent additions of alkanediol, surfactant and water, with homogenisation carried out using a “T25 Ultra-turrax®” disperser with a “S25EC-T-C-25F” dispersion tool at 18,000 rpm for two minutes.

TABLE 6

| | Alkanediol | Surfactant (1) | Water | |
|---|---|---|---|---|
| Butane-2,3-diol | 2% | 2% | 96% | n = 5 |
| Hexane-1,6-diol | 2% | 2% | 96% | n = 5 |
| Hexane-2,5-diol | 2% | 2% | 96% | n = 5 |
| Pentane-1,2-diol | 2% | 2% | 96% | n = 5 |

(1) = Tween 20 ® (Sigma Aldrich)

The compositions listed in Table 6 were tested by spraying (100 ml/m²) on perennial ryegrass (Lolium perenne L.) plants (BBCH 16-17 stage) in 5 repetitions (n=5). In this case, a repetition corresponds to a pot comprising 40 to 45 perennial ryegrass plants.

Water was sprayed (100 ml/m²) on other perennial ryegrass (Lolium perenne L.) plants (BBCH 16-17 stage) (negative control).

After treatment with the different compositions, the plants were maintained under the following conditions: temperature of 25±5° C. and RH (relative humidity) of 60±10%.

The herbicidal effect of the different formulations was assessed over a 10-day period, in terms of the percentage mortality of perennial ryegrass plants.

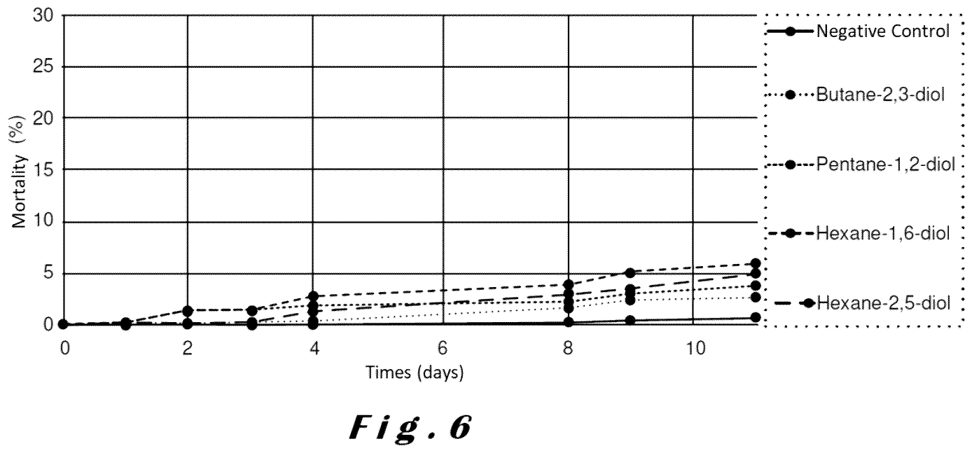

The results are shown in FIG. 6. As may be seen, hexane-1,6-diol, hexane-2,5-diol and pentane-1,2-diol systematically show an increased herbicidal activity on the perennial ryegrass (Lolium perenne L.) compared with the herbicidal activity observed for butane-2,3-diol. In fact, the % mortality measured for hexane-1,6-diol, hexane-2,5-diol and pentane-1,2-diol are always higher than for butane-2,3-diol.

In addition, each of these compounds from the alkanediol family had a herbicidal effect on the perennial ryegrass (Lolium perenne L.), since % mortality significantly different from the negative control were measured for each of the formulations.

The present disclosure has been described above in connection with specific embodiments, which are illustrative and should not be considered limiting. Generally speaking, it will be obvious to the person skilled in the art that the present disclosure is not limited to the examples illustrated and/or described above.

The use of the verbs “comprise”, “include”, or any other variant, as well as their conjugations, may in no way exclude the presence of elements other than those mentioned.

The use of the indefinite article “a”, “an”, or the definite article “the”, to introduce an element does not exclude the presence of a plurality of these elements.

1. A use of a compound of an alkanediol family as a non-selective or selective total herbicide, in particular a use of a compound of the alkanediol family as a non-selective or selective total herbicide to obtain a phytotoxic effect comprising an inhibition of an germination of seeds or a destruction of the seeds, the inhibition of a resumption of an underground or an aerial development of meristems and buds or the destruction of underground or the aerial meristems and buds, the inhibition of the development and of growth of roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant, said compound of the alkanediol family comprising at least 5 carbon atoms.

2. The use according to claim 1, wherein said compound of the alkanediol family comprising at least 5 carbon atoms is a linear or cyclic or branched alkanediol.

3. The use according to claim 1, wherein said compound of the alkanediol family comprising at least 5 carbon atoms is chosen from the group consisting of hexane-1,2-diol, octane-1,2-diol, decane-1,2-diol, dodecane-1,2-diol, octane-1,8-diol, nonane-1,9-diol, pentane-1,2-diol, hexane-1,6-diol, hexane-2,5-diol, and mixtures thereof.

4. The use according to claim 1, wherein said compound of the alkanediol family comprising at least 5 carbon atoms is an alkanediol of natural origin, for example a bio-sourced alkanediol, or an alkanediol being a co-product of a chemical synthesis method.

5. The use according to claim 1, wherein said compound of the alkanediol family comprising at least 5 carbon atoms is present in a formulation comprising a solvent and/or a co-formulant selected from a group comprising detergents, emulsifiers, surfactants or tensioactives, dispersants, anti-foaming agents, penetration enhancers in plant tissues, humectants, ionic and non-ionic wetting agents, antioxidants, thickeners, buffers, diluents, and mixtures thereof.

6. The use according to claim 5, wherein said compound of the family of alkanediols comprising at least 5 carbon atoms is present in said formulation in a proportion of 0.01% to 50% by volume relative to a total volume of said formulation, preferably in a proportion of 0.5% to 10% by volume relative to the total volume of said formulation, more preferably in a proportion of 1% to 5% by volume relative to the total volume of said formulation.

7. The use according to claim 5, wherein said tensioactive or surfactant is present in said formulation in a proportion of 0.01% to 20% by volume relative to a total volume of said formulation, preferably in a proportion of 0.1% to 10% by volume relative to the total volume of said formulation, more preferably in a proportion of 0.5% to 5% by volume relative to the total volume of said formulation.

8. The use according to claim 5, wherein said solvent is selected from the group consisting of water, alcohols, ketones, esters, fatty acid esters, ethers, polyols, alkanes, vegetable or mineral oils, modified vegetable oils, and mixtures thereof.

9. The use according to claim 5, wherein said tensioactive or surfactant is chosen from the group consisting of the following compounds: isooctadecanoic acid, propane-1,2,3-triol, propylene glycol alginate, glycerol caprate, casein, sucrose cocoate, glycerol dilaurate, poly(ethylene glycol) distearate, sucrose distearate, docosanamide, polyoxyethylene lauryl ether, polyethylene glycol monoketyl ether, hexaethylene glycol monooctyl ether, polyethylene glycol monooleyl ether, hydroxyethylcellulose, hydroxypropylmethylcellulose, cetyl lactate, lecithin, coconut monoglycerides, monocaprylin, glycerol monohydroxystearate, glycerol monolaurate, sorbitan monolaurate, monomyristin, glycerol monooleate, sorbitan monooleate, sorbitan monopalmitate, myristyl myristate, isopropyl myristate, 2-[bis(2-hydroxyethyl)amino]ethyl octadecanoate, decyl oleate, isooctyl palmitate, 2-[2-hydroxyethyl-[(Z)-octadec-9-enyl]amino]ethanol, polyoxyethylene glycol dodecyl ether, polysorbate 20, polysorbate 40, polysorbate 60, polysorbate 80, polysorbate 85, saponins, sorbitan sesquioleate, polyoxyethylene stearate, sucrose stearate, sorbitan stearate, pentaerythrityl tetrastearate, glycerol trilaurate, sorbitan trioleate, triolein, glycerol tristearate, sorbitan tristearate, and mixtures thereof.

10. The use according to claim 5, wherein said formulation additionally comprises at least one additional compound exhibiting herbicidal properties.

11. The use according to claim 5, wherein said formulation is in the form of a liquid, in the form of a liquid concentrate to be diluted, in the form of a macroemulsion, a microemulsion or a nanoemulsion, in the form of a concentrated macroemulsion to be diluted, of a concentrated microemulsion to be diluted or of a concentrated nanoemulsion to be diluted, in the form of a powder, in the form of granules, pills, wettable granules or wettable powder or in the form of an aerosol.

12. The use according to claim 11, wherein said formulation in the form of a liquid, in the form of a liquid concentrate to be diluted, in the form of a macroemulsion, a microemulsion or a nanoemulsion, in the form of a concentrated macroemulsion to be diluted, a concentrated microemulsion to be diluted or a concentrated nanoemulsion to be diluted or in the form of an aerosol, has drops with a drop size distribution D90 equal to 15 μm.

13. A method comprising:
applying a compound from an alkanediol family comprising at least 5 carbon atoms to at least part of a plant, a seed or a soil, and
obtaining a non-selective or selective total herbicidal effect, in particular obtaining a phytotoxic effect comprising an inhibition of an germination of the seeds or a destruction of the seeds, the inhibition of a resumption of an underground or an aerial development of meristems and buds or the destruction of the underground or the aerial meristems and buds, the inhibition of the development and of growth of roots and/or rhizomes and/or tubers and/or hypocotyls and/or epicotyls and/or plantlets and/or aerial parts of a plant or the destruction of the roots and/or rhizomes and/or tubers and/or hypocotyls and/or epicotyls and/or plantlets and/or aerial parts of a plant.

14. The method according to claim 13, wherein said application is performed on the entire plant and/or the leaves and/or the flowers and/or the fruits and/or the seeds on the plant and/or the plantlets and/or the transplanted seedlings and/or the propagation material such as seeds, tubers or rhizomes, by spraying, dipping, injection or administration by fertilisation or irrigation systems.

15. The method according to claim 14, wherein said application of a compound from the alkanediol family comprising at least 5 carbon atoms to at least part of a plant, a seed or a soil, is an application of a compound from the alkanediol family comprising at least 5 carbon atoms chosen from the group consisting of hexane-1,2-diol, octane-1,2-diol, decane-1,2-diol, dodecane-1,2-diol, octane-1,8-diol, nonane-1,9-diol, pentane-1,2-diol, hexane-1,6-diol, hexane-2,5-diol, and mixtures thereof.

16. The method according to claim 13, wherein said application of a compound from the alkanediol family comprising at least 5 carbon atoms to at least part of a plant, a seed or a soil, is an application of a compound from the alkanediol family comprising at least 5 carbon atoms chosen from the group consisting of hexane-1,2-diol, octane-1,2-diol, decane-1,2-diol, dodecane-1,2-diol, octane-1,8-diol, nonane-1,9-diol, pentane-1,2-diol, hexane-1,6-diol, hexane-2,5-diol, and mixtures thereof.
